(19) United States
(12) Patent Application Publication
(10) Pub. No.: US 2002/0081557 A1
(43) Pub. Date: Jun. 27, 2002

(54) Personal learning and motivational kit and method

(76) Inventor: Michael L. Altshuler, Boynton Beach, FL (US)

Correspondence Address: Oltman, Flynn & Kubler, Suite 415, 915 Middle River Drive, Ft. Lauderdale, FL, 33304-3585, US

(21) Appl. No.: 09/748,818

(22) Filed: Dec. 22, 2000

(51) Int. Cl. G09B 19/00

(52) U.S. Cl. 434/236

(57) ABSTRACT

A learning and motivational kit and method in which daily learning and motivational messages (including a commitment for each day) are displayed paginally for study by the person to be motivated to act, a note pad is provided on which the person writes down the day's commitment and then recites it aloud, and portable daily cards, each displaying a condensed version of the respective day's learning and motivational message with commitment statement which is to be read by the user during the day.

### BACKGROUND OF THE INVENTION

1. Field of the Invention

This invention relates to a personal learning and motivational kit and method for training a person to take certain action(s) to achieve specified results, such as personal growth and development, improved job performance (e.g., salesmanship), or some other worthy goal.

2. Prior Art

Various behavioral aids and methods have been proposed heretofore to focus a person on a particular goal, such as better diet, improved health, or improved job performance. Examples of such proposals are disclosed in the following U.S. Pat. No. Johnson U.S. Pat. No. 3,281,966; U.S. Pat. No. Clark 4,976,622; Bussiere U.S. Pat. No. 5,090,733; Strecher U.S. Pat. No. 5,207,580; Saari U.S. Pat. No. 5,338,202; and Evans U.S. Pat. No. 5,573,405.

### SUMMARY OF THE INVENTION

One aspect of the present inventions relates to a novel learning and motivational kit for convenient use by a person to study a learning and motivational message with several topics or points and commitment statements at the beginning of the day, and to refresh his or her understanding of that message at intervals during the day by referring to a portable card with an abbreviated or concentrated version of that message and commitment. Preferably, the kit has a pad of note paper with pen on which the user writes the daily commitment contained in that day's learning and motivational message immediately after reading that message. After writing down the day's commitment the user recites that commitment aloud two or more times to reinforce its lesson.

Another aspect of this invention relates to a novel method of motivating a person toward a specified behavioral objective by means of the foregoing kit and additional closely related steps involving the selected and repeated use of some of its features in accordance with the user's perception of how it will be most helpful on that particular day.

Further novel and advantageous characteristics and objectives of this invention will be apparent from the following detailed description of a presently preferred embodiment thereof, shown in the accompanying drawings.

### BRIEF DESCRIPTION OF THE DRAWINGS

FIG. 1 is a front perspective view of a motivational kit in accordance with the present invention;

FIGS. 2 and 3 show a ring-bound kit open and closed;

FIG. 3a shows the easel set up; and

FIG. 4 is a flow chart illustrating the novel learning and motivational method of this invention.

### DETAILED DESCRIPTION OF THE INVENTION

Before explaining the present invention in detail it is to be understood that the invention is not limited in its application to the particular arrangements shown and described herein since the invention is capable of other embodiments. Also, the terminology used herein is for the purpose of description and not of limitation.

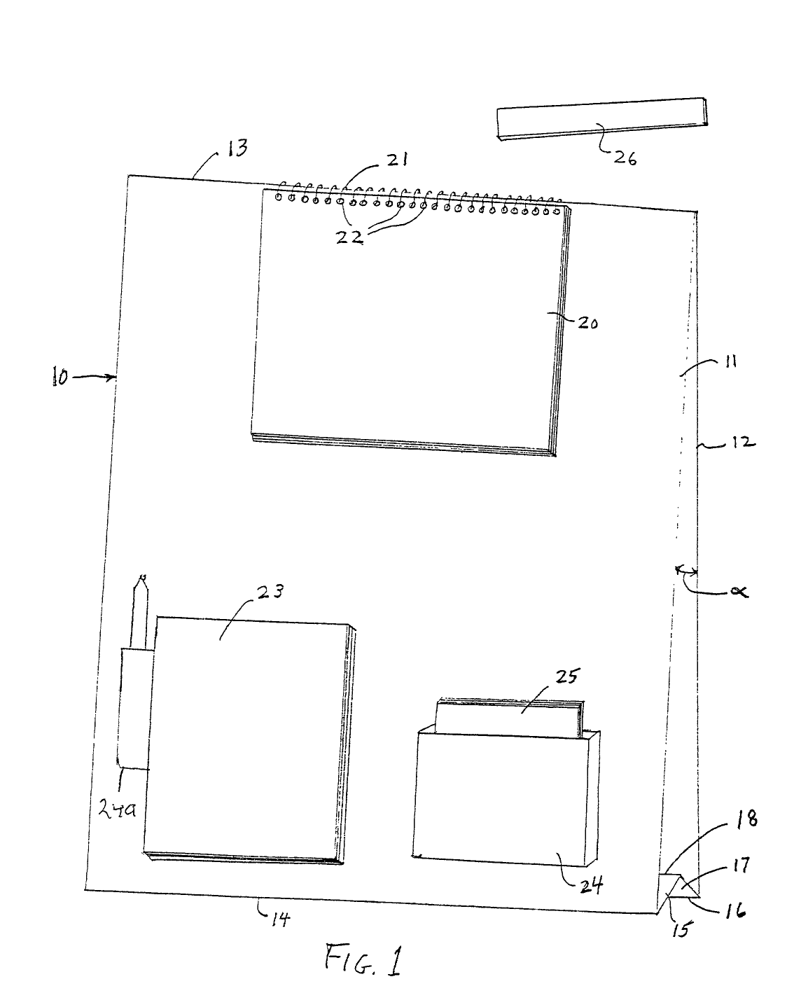

Referring to FIG. 1, in accordance with a preferred embodiment of the present invention a unitary holder 10 is provided in the form of a self-supporting easel having a thin, flat, rectangular, substantially rigid, front panel 11 and a similar back panel 12 connected to the front panel along a straight horizontal fold line 13 at the top. Downward from their top edges the panels diverge at a slight angle K. The front panel 11 terminates at its lower end in a straight horizontal bottom edge 14 behind which a front bottom segment 15 extends rearward and upward at a slight angle. The back panel terminates at its lower end in a straight horizontal bottom edge 16 from which a rear bottom segment 17 extends forward and upward at a slight angle to its juncture with the front bottom segment 15 along a straight horizontal fold line 18.

At the top the easel supports a unitary paginal assembly of large cards 20, each displaying a complete learning and motivational message for a day on a particular topic or theme relating to personal growth and development, or job performance, and/or some other aspect of the user's personal and/or professional life. The cards are spiral bound to the easel at the top by a wire helix 21. At the beginning of each day, the previous day's card 20 can be flipped over to hang behind the easel, making today's card visible at the front of the easel. The wire helix 21 extends through a horizontal row of openings 22 formed in each large card 20 across its width near the top and through corresponding openings formed in the front and back panels 11 and 12 of the easel just below the fold line 13 at the top.

Toward its lower left comer the front panel 11 of the easel supports a pad of small sheets of note paper 23. Each sheet may have a narrow band of adhesive or pressure sensitive adhesive on the back on top which permits ready removal of the top sheet from the pad each day. These note paper sheets are to be written on by the person using the kit (the person being motivated to take action), as explained hereinafter.

Also attached to the front panel near the pad are pen and pen-holder 24a. Toward its lower right corner the front panel 11 supports an open-topped pocket or envelope 24 which holds a plurality of removable, portable, small cards 25, one behind the other. Each portable card 25 is of a size enabling it to fit conveniently in a person's shirt pocket or wallet. Each card 25 displays an abbreviated, condensed or distilled version of the learning and motivational message and commitment statement expressed more fully on the large spiral-bound card 20 for the same day. There is, of course, a portable small card 25 for each day corresponding to the spiral-bound card 20 for that same day.

The following is an example of the first day's learning and motivational message displayed on the corresponding spiral-bound card 20:

### Start With the End in Mind

To be successful in life, you first must know what you want, then why you want it, and finally you must figure out how you're going to get it.

Before beginning any task, know what you want your final outcome to be.

If you don't clearly know what you want, how do you expect to get it?

The clearer and more specific your objective in the beginning, the better your results in the end.

Never lose sight of your objective and why you want to achieve it.

### “You are the Answer!”

My commitment today: I will write down and stay focused on the desired outcome of one significant task or goal, then notice how it improves my ability to accomplish that task or goal.

The message on the front of the small portable card 25 for this day is:

### Start With the End in Mind

My commitment today: I will write down and stay focused on the desired outcome of one significant task or goal, then notice how it improves my ability to accomplish that task or goal.

### “You are the Answer!”

The quote on the back of this portable card 25 is printed over a motivational pose or photograph as follows:

“Your past is important, but as important as it is, it is not nearly as important to your present as the way you see your future.” —Dr. Tony Campolo

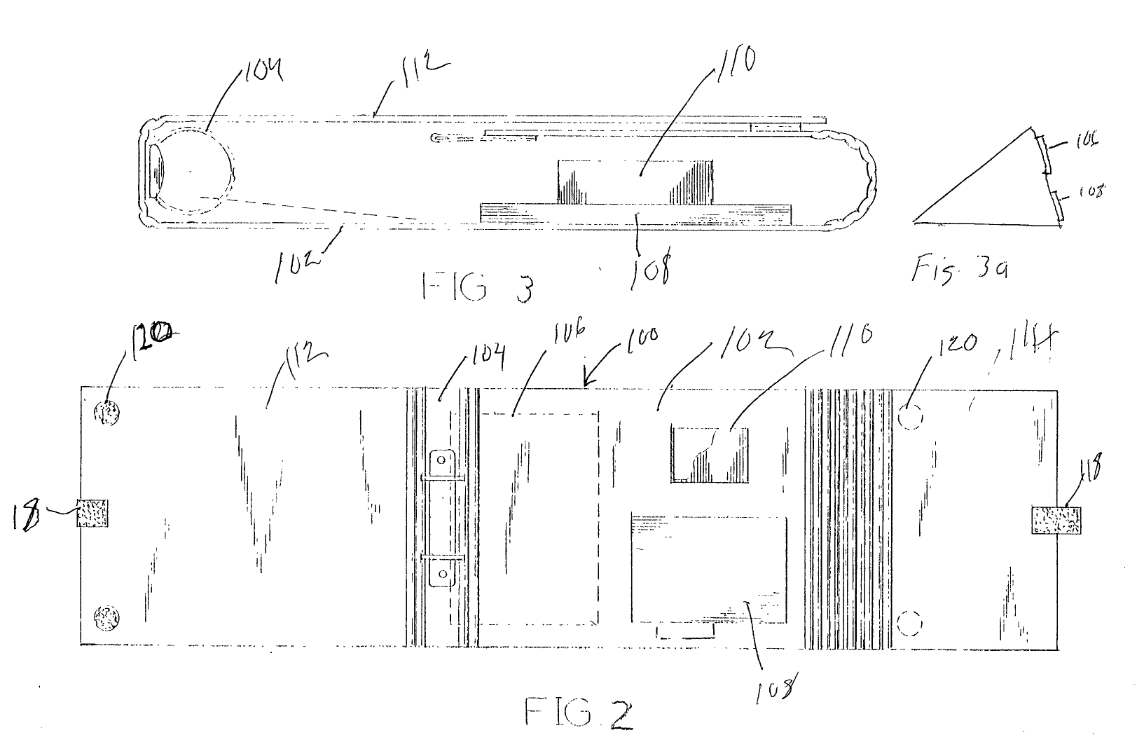

FIGS. 2 and 3 show another embodiment which is a modification of the embodiment of FIG. 1. In FIG. 2, the box holder 100 is shown open, and it has a unitary holder section 102 at the middle, and a ring binder 104 at the left. Cards 106 go in the ring binder. There is a pad holder 108 and a pocket 110 as in the first embodiment.

The left cover 112 folds over the rings, and the right cover 114 folds over the pocket and pad holder, as shown in FIG. 3, and the covers are fastened together by means of VELCRO® tabs 120. VELCRO® tabs 118 are used to secure and set up the box holder 100 into a ready to use easel display.

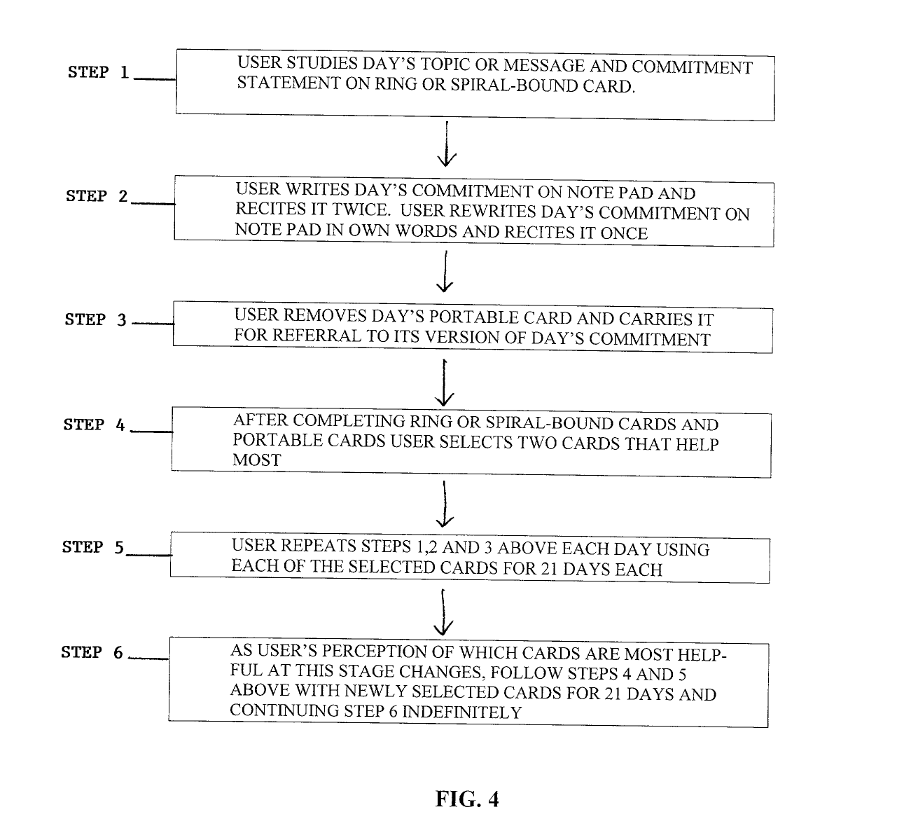

In accordance with the novel method of this invention (FIG. 4), the person being motivated to act first listens to a learning and motivational audio tape which describes why the kit is more effective than conventional books and tapes, how and why it was created, how to overcome challenges when using the kit, and general motivational material. Then they study the full learning and motivational message for the day that appears on the spiral-bound card 20 for this day (step 1). That message includes several topical points (in the foregoing example, the sentences preceded by a bullet) and the user's commitment for that day.

In the next step (2) of this method, the user writes one or more times on the top sheet of note pad 23 and 108 the user's personal commitment for that day, which may be in the same words as the commitment as stated on the ring-bound or spiral-bound card 20 and 106 for this day or may paraphrase it, provided it has the same essential thought. In step (2) he or she rewrites it one or more times in his/her own words. Preferably, to reinforce this commitment the user reads aloud one or more times each version of the commitment he or she has just written down.

Next (step 3), the user removes from the easel pocket 24 or 110 the portable card 25 for that day and carries it with him or her all day long, such as in a shirt pocket, or purse, or anywhere it will be seen or touched throughout the day, and refers to it from time to time to stay focused on that day's learning and motivational message and commitment.

The user performs this routine preferably one card a day for a designated period of time, such as 28 days, using a different pair of spiral-bound or ring bound and portable cards 20 and 25 (FIG. 1) each day in the series. At the end of this period, the user reflects on his or her experience to date and makes a selection of two cards that the user considers will be the most helpful. (step 4).

Using the cards from this selection, the user repeats the foregoing steps 1, 2 and 3, concentrating on the learning and motivational messages and commitment statements conveyed by those two cards (step 5) for 21 days.

Any time the user decides that two cards 20 and 25 (FIG. 1) would be more helpful here and now, the user makes a new selection of two cards and focuses on their learning and motivational messages and commitment statement for 21 days until such time as the user decides that his or her present needs would be better met by two cards other than these (step 6).

From the foregoing it will be evident that the present invention provides an effective technique for motivating a person to take action on a commitment toward a desired behavioral goal by presenting him or her a daily learning and motivational message whose impact is reinforced by involving the person's own active participation and by providing a readily accessible reminder of that message and commitment throughout the day.

I claim:

1. A personal learning and motivational kit comprising: a unitary paginal assembly of cards, each displaying an individual learning and motivational message for the day, said paginal assembly displaying said cards one at a time for viewing by a person using the kit; a plurality of portable cards, each displaying an abbreviated version of the message shown on a corresponding card of said paginal assembly; and a pocket on said holder holding said portable cards, one behind the other, and permitting manual removal of an individual portable card by said person to be carried by said person during the day.

2. A kit according to claim 1, wherein each card of said paginal assembly and each portable card displays a commitment for the day, and further comprising: a note pad on said holder to be written on by said person for recording the person's commitment for that day.

3. A kit according to claim 2, wherein said holder presents a front face at which said cards of said paginal assembly, said pocket and said note pad are exposed.

4. A kit according to claim 1, wherein said holder is a self-supporting easel, and said cards of said paginal assembly are spiral-bound to said easel at the top.

5. A kit according to claim 3, wherein said holder is a self-supporting easel, and said cards of said paginal assembly are spiral-bound to said easel at the top.

6. A kit according to claim 3, wherein said holder is part of a box containing a ring binder.

7. A learning and motivational method which comprises the steps of: providing a unitary paginal display of individual learning and motivational messages and commitment statement for the day to be read by a person who is to be motivated to act; and providing a plurality of portable and removable reminders, each displaying a condensed version of the corresponding day's message with commitment statement appearing on said paginal display, to be carried by said person and referred to for reinforcing the day's message and commitment.

8. A method according to claim 7, and further comprising the step of: providing a note pad adjacent said paginal display on which the person writes the day's commitment corresponding to the message for the day presented on said paginal display.

9. A method according to claim 8 in which the person recites aloud the day's commitment written on said note pad.
